(19) United States
(12) Patent Application Publication
(10) Pub. No.: US 2004/0178283 A1
(43) Pub. Date: Sep. 16, 2004

(54) Fuel injection device with a 3/2 way valve

(76) Inventor: Peter Boehland, Marbach (DE)

Correspondence Address: Ronald E Greigg, Greigg & Greigg, Suite One, 1423 Powhatan Street, Alexandria, VA, 22314, US

(21) Appl. No.: 10/478,182

(22) PCT Filed: Dec. 11, 2002
(86) PCT No.: PCT/DE02/04542

(30) Foreign Application Priority Data
Mar. 20, 2002 (DE) 10212396.9

(51) Int. Cl. F02M 47/02

(52) U.S. Cl. 239/88; 123/446

(57) ABSTRACT

The invention relates to an apparatus for injecting fuel, with a fuel pump for each cylinder of the internal combustion engine, which contains a pump piston that is driven in a stroke motion. This pump piston delimits a pumping chamber, which is supplied with fuel from a fuel tank. The fuel injection apparatus also has a fuel injection valve (25) that has a pressure chamber (22) connected to the fuel pump (13) and has an injection valve element (18) that controls at least one injection opening (24). The pressure prevailing in a pressure chamber (22) can move the injection valve element (18) in an opening direction counter to a closing force in order to unblock the at least one injection opening (24) while a pressure prevailing in a control chamber (14) acts at least indirectly on the injection valve element (18) in the closing direction. The control chamber (14) can be pressure-relieved by means of a control valve (31) that can be actuated by an actuator (3). The control valve (31) has a control valve element (32) with a first valve section (33) and a second valve section (36), which are each enclosed by a respective hydraulic chamber (34, 39), of which the first hydraulic chamber (34) communicates with a high-pressure inlet (30) and the second hydraulic chamber (39) can be used to exert pressure on the control chamber (14).

### TECHNICAL FIELD

In direct-injection internal combustion engines, unit injector systems (UIS) or unit pump systems (UPS) are used. In these injection systems, the injectors are connected to a high-pressure source by means of a short line or a bore. At a nominal engine speed, these injection systems can generate a very high peak pressure. As a rule, these injection systems use on-off valves that control 300 to 500 times the pressure in comparison to when they are used in spark-ignition engines and switch significantly more frequently.

### PRIOR ART

A known fuel injection apparatus has a fuel pump for each cylinder of the engine, which has a pump piston that is driven into a stroke motion by the engine. This pump piston delimits a pumping chamber that is connected via a line to a fuel injection valve disposed separate from the fuel pump in the engine. The fuel injection valve has an injection valve element that controls at least one injection opening. The pressure generated in the pumping chamber can move this injection valve element in the opening direction counter to a closing force. A first electrically triggered control valve is provided, which controls a connection of the pumping chamber to a relief chamber and is disposed close to the fuel pump. In addition, a second electrically triggered control valve is provided, which is disposed close to the fuel injection valve and controls the pressure prevailing in a control chamber of the fuel injection valve. This pressure acts on the injection valve element at least indirectly in the closing direction.

A disadvantage of this design is the fact that two electrically triggered control valves must be provided, which increases the production costs and complexity of this injection apparatus.

In this other known fuel injection apparatus, each cylinder of an internal combustion engine is provided with a high-pressure fuel pump that has an associated fuel injection valve connected to it. A pump piston of the high-pressure fuel pump is driven into a stroke motion by the engine, e.g. by means of its camshaft, and delimits a pumping chamber that communicates with a pressure chamber of the fuel injection apparatus. This includes an injection valve element that controls at least one injection opening and can be moved in an opening direction counter the closing force by the pressure prevailing in the pressure chamber. A first control valve device controls an unthrottled connection and a connection via a throttle restriction, which connections extend between the pumping chamber and a relief chamber. An additional, second control valve device controls a connection between the relief chamber and a control pressure chamber of the fuel injection valve connected to the pumping chamber. The pressure prevailing in the control pressure chamber acts on the injection valve element in the closing direction.

This design allows a main injection phase to be preceded by a preinjection phase at a reduced pressure level; however, this design also requires two separate control valve devices to be provided.

EP 0 957 261 A1 likewise relates to a fuel injection apparatus. This fuel injection apparatus has a high-pressure fuel pump and a fuel injection valve connected to it for each cylinder of the engine. The high-pressure fuel pump has a pump piston, which the engine sets into a stroke motion and which delimits a pumping chamber. The fuel injection valve has a pressure chamber connected to the pumping chamber and has an injection valve element, which controls at least one injection opening and which the pressure prevailing in the pressure chamber can move in the opening direction counter to a closing force in order to unblock the at least one injection opening. A first control valve device comprised of a control valve is provided, which controls a connection of the pumping chamber to a relief chamber. A second control valve device comprised of a control valve is also provided, which controls a connection of a control pressure chamber to a relief chamber. The pressure prevailing in the control pressure chamber acts on the injection valve element at least indirectly in the closing direction and the control pressure chamber is connected to the pumping chamber. A shared electromagnetic actuator switches both of the control valve devices. The disadvantage of this known fuel injection apparatus is that it is only possible to inject fuel at the pressure level generated by the fuel pump and it is not possible to vary the pressure with which the fuel injection apparatus operates.

### DESCRIPTION OF THE INVENTION

The advantages of the design according to the invention lie primarily in the fact that the same functions are achieved by using a single control valve body in the form of a 3/3-way valve integrated into an injector housing as are achieved in injection systems known from the prior art that use two separate electrically triggered control valve devices. When it comes to shaping preinjection phases and main injection phases, the injection curve is shaped by only one valve so that on the one hand, the design proposed according to the invention is less complex in its triggering and on the other hand, can also be produced at a more reasonable price due to the elimination of an additional, second control valve device of the kind known from the prior art. The efficiency and spraying action that can be achieved by an injection system designed according to the invention does not differ significantly from the efficiency and spraying action of injection systems with two electrically triggered control valve devices.

The valve sections disposed in succession on the control valve element of the 3/3-way control valve proposed according to the invention permit the design according to the invention to achieve short switching paths and therefore short switching times, thus allowing preinjections and secondary injections to be easily produced as needed through multiple switching of an actuator embodied as a solenoid valve. In a unit injector system or a unit pump system, the 3/3-way control valve proposed according to the invention can be actuated by a magnetic actuator, a piezoelectric actuator, or the like. When an electromagnetically operating actuator is used, the control valve element of the 3/3-way control valve can be provided with a solenoid plunger in its head region, whose socket has the magnetic coil integrated into it. Alternatively, the control valve element of the 3/3-way control valve can also be actuated by means of a magnetic coil affixed in the injector housing; a flat armature plate can then be provided in the head region of the control valve element of the 3/3-way control valve.

A prestressing force preferably acts on the end of the control valve element of the 3/3-way control valve oriented away from the actuator. The prestressing force can be exerted, for example, by means of two parallel-connected, concentrically disposed spring elements, one of which acts on the bottom end surface of the control valve element directly or with the interposition of a disk-shaped element, while the other spring element encompassing the first valve element can be encompassed by a stop that is disposed so that it can move inside the housing of the injector body. Adjusting the position of this spring-loaded stop allows a desired initial injection pressure to be set, which can be overcome through a corresponding increase in the power supplied to the actuator embodied as a solenoid valve, thus allowing the control valve element proposed according to the invention to be moved into another switched position.

### DRAWINGS

The invention will be described in more detail below in conjunction with the drawings.

FIG. 1 shows a unit injector system (UPS=unit pump system) with a controllable nozzle, without a high-pressure pump,

FIG. 2 shows a unit injector system with a 3/3-way control valve,

FIG. 3.1 shows the 3/3-way control valve in a first switched position (valve open),

FIG. 3.2 shows the 3/3-way control valve in a second switched position (seat valve section open and slide valve section closed),

FIG. 3.3 shows the 3/3-way control valve in a third switched position (both valve regions closed),

FIG. 4 shows the curves of the pump pressure, solenoid valve force, solenoid valve stroke, and stroke path of the spring-loaded stop inside the injector housing, plotted as a function of the camshaft angle, and

FIG. 5 shows the curves of the nozzle pressure, nozzle needle stroke, control chamber pressure, and injection rate, plotted as a function of the camshaft angle.

### EXEMPLARY EMBODIMENTS

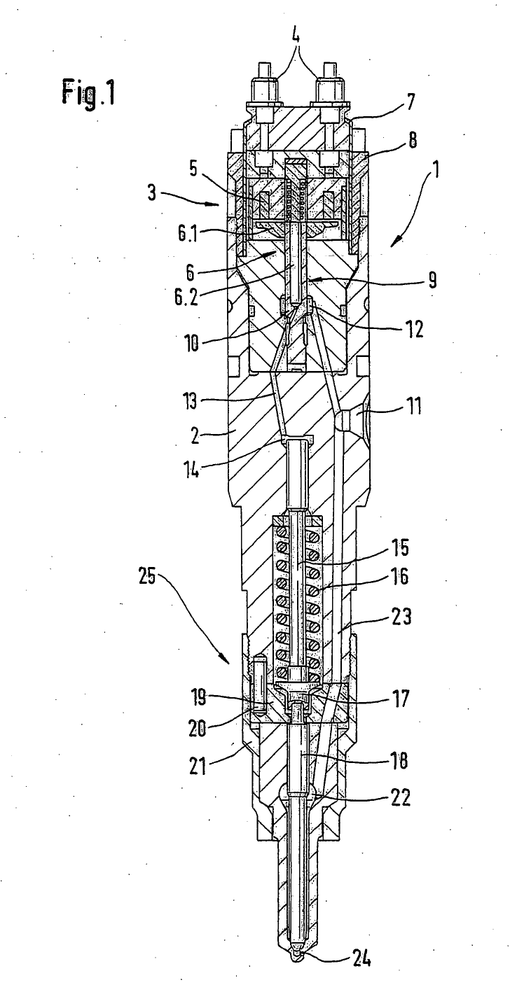

FIG. 1 shows a unit injector system (UPS) with a controllable nozzle, without depicting a high-pressure source, for example a high-pressure pump.

FIG. 1 shows an injector 1 known from the prior art, whose injector body 2, in its upper region, contains an actuator 3 embodied in the form of a solenoid valve. The actuator 3 is triggered by means of connections 4 and includes a magnetic coil 5. Disposed opposite from the magnetic coil 5 of the actuator 3 is a flat armature plate 6.1 that is associated with an armature device 6. In addition to the flat armature plate 6.1, the armature device 6 includes an armature pin 6.2. A magnetic sleeve 7 encompasses the magnetic coil 5 of the actuator 3. The actuator 3 is screwed into the head region of the injector body 2 by means of a retaining nut 8.

The injector body 2 contains a valve 9, which includes a valve element 10 and can be actuated by the actuator 3. Inside the injector housing 2, the valve element 10 is encompassed by an annular chamber 12, which in turn is connected to a high-pressure inlet 11 via a supply line. The high-pressure inlet 11 is connected to a high-pressure pump or its pumping chamber, not shown in FIG. 1.

From the annular chamber 12 inside the injector body 2, an inlet 13 branches off to a control chamber 14 inside the injector body 2. The control chamber 14 acts on the upper end of a push-rod-shaped transfer element 15, which is encompassed by a closing spring 16 embodied in the form of a helical spring. The upper end of the closing spring 16 is supported inside the injector body 2 and its lower end is supported against a thrust-transmitting piece 17, which in turn acts on an injection valve element 18, e.g. embodied in the form of a nozzle needle. The thrust-transmitting piece 17 is accommodated in a disk-shaped intermediate piece 19, which is centered in relation to the injector body 2 by means of a centering pin 20. The injector body 2, the disk-shaped intermediate piece 19, and the injection valve element 18 are fixed in relation to one another by means of a nozzle retaining nut 21. The injection valve element 18 is encompassed by a pressure chamber 22 and communicates with the high-pressure inlet 11 by means of a supply line 23 that extends through the injector body 2, the disk-shaped element 19, and the nozzle body.

Inside the pressure chamber 22, a pressure step is provided on the injection valve element 18, which permits an opening of the injection valve element 18 when the pressure is reduced in the control chamber 14 inside the injector body 2. When the pressure in the control chamber 14 is relieved through actuation of the control valve 9, which causes the injection valve element 18 to open, fuel is injected into the combustion chamber of a direct-injection internal combustion engine, not shown in detail here, through injection openings 24 indicated at the combustion chamber end of the injection valve element 18. The injection valve device, which is labeled with the reference numeral 25, is disposed at the combustion chamber end of the injector 1 and includes the injection valve element 18, the nozzle body, the pressure chamber 22, and the nozzle retaining nut 21.

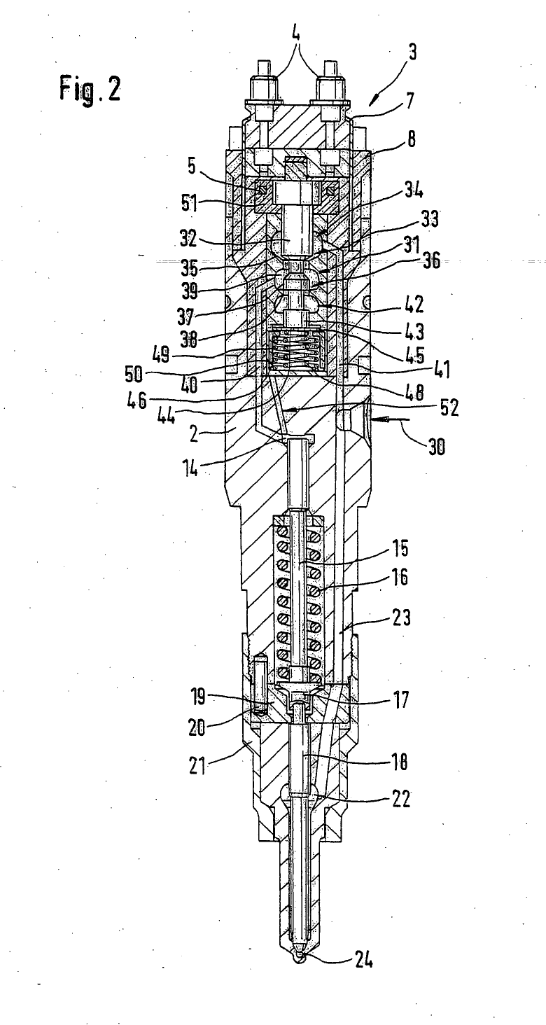

FIG. 2 shows a unit injector system with an actuator embodied as a solenoid valve.

FIG. 2 shows the design proposed according to the invention for a unit injector system. In the upper region of the injector body 2, an actuator 3 embodied as a solenoid valve is provided, which is triggered by means of connections 4. The actuator 3 is encompassed by a sleeve-shaped casing 7 and is fastened in the head region of the injector body 2 by means of a retaining nut 8.

In the exemplary embodiment shown in FIG. 2, the magnetic coil 5 of the actuator 3 embodied as a solenoid valve is integrated into an insertion piece 51, which is disposed in the head region of a control valve element 32 of a 3/3-way control valve 31.

In lieu of the components 5 and 51 in the solenoid plunger design shown in FIG. 2, the head region of the control valve element 32 of the 3/3-way control valve 31 can also contain a flat armature plate 6.1, which, in such an embodiment, cooperates with a magnetic coil 5 integrated into the magnetic core of the actuator 3 according to the depiction of the injector in FIG. 1.

In the region adjoining the underside of the control chamber 14, which can be acted on by pressure or can be pressure-relieved, the injector body 2 and the injection valve 25 contained in it are embodied analogous to those in the injector described above in conjunction with FIG. 1.

The highly pressurized fuel travels via a high-pressure pump inlet 30 that feeds laterally into the injector body 2, into the inlet 23, and to a pressure chamber 22 that is contained in the injection valve 25 and encompasses the injection valve element 18 in the region of a pressure step embodied on it. The high pressure prevailing in the control chamber 14 acts on the injection valve element 18, with the interposition of a thrust-transmitting piece 17 of a rod-shaped transfer element 15, which is encompassed by a closing spring 16.

An inlet 41 extends from the high-pressure pump inlet 30, toward the actuator 3 that can be embodied as a solenoid valve, to a first hydraulic chamber 34, which encompasses the control valve 32 of the 3/3-way control valve in the region of a first valve section 33. In the exemplary embodiment according to FIG. 2, the first valve section 33 is embodied as a seat valve. The first valve section 33 includes a seat surface 35, which cooperates with a corresponding surface of the housing encompassing the control valve element 32. After the first valve section 33, viewed in the closing direction of the injection valve element 18, the control valve element 32 of the 3/3-way control valve 31 is provided with another, second valve section 36, which is embodied as a slide valve section. The second valve section 36 of the control valve element 32 is provided with control edges 37 that cooperate with housing control edges 38 of the housing encompassing the control valve element 32. In addition, the second valve section 36 is encompassed by a second hydraulic chamber 39 from which a control chamber supply line 40 branches, which feeds into the control chamber 14 that acts at least indirectly on the injection valve element 18.

Underneath the second valve section 36 on the control valve element 32, there is a piston section 43, which is encompassed by a third, hydraulic chamber 42 on the low-pressure side. The end surface 44 of the piston section 43 can be acted on by a first spring element 48 contained in the cavity 50, for example with the interposition of a disk-shaped element 45. In the cavity 50 underneath the control valve element 32 in the injector body 2, the first spring element 48 is encompassed by an additional, second spring element 49 embodied as a helical spring, which in turn acts on a stop 46 that is disposed so that it can move inside the cavity 50 of the injector body 2. The movably contained stop 46 has a collar surface 47 that encompasses the upper end of the second spring element 49. In a preferred embodiment, the first spring element 48, which acts indirectly on the control valve element 32, and the second spring element 49, which acts on the spring-loaded stop 46, are connected in parallel. Appropriate dimensioning of the first spring element 48 and the second spring element 49, which acts on the spring-loaded stop 46, permits one to preset the buildup of a particular initial injection pressure. Through an appropriate increase in the supply of power to the spring packet 48 and 49, this prestressing force can be appropriately designed to set an initial injection pressure; the prestressing force exerted by the spring packet 48 and 49 can be can be overcome through a corresponding supply of power to the actuator 3 embodied as a solenoid valve.

By contrast with the embodiment of an injector 1 known from the prior art shown in FIG. 1, in the design proposed according to the invention, the control chamber 14 is connected on the one hand via a control chamber supply line 40 to the second hydraulic chamber 39, which encompasses the second valve section of the control valve element 32; in the other hand, the control 14 that can be pressure-relieved is connected via a relief line 52 to the cavity 50 and for further pressure relief, is connected to the third hydraulic chamber 42 on the low-pressure side.

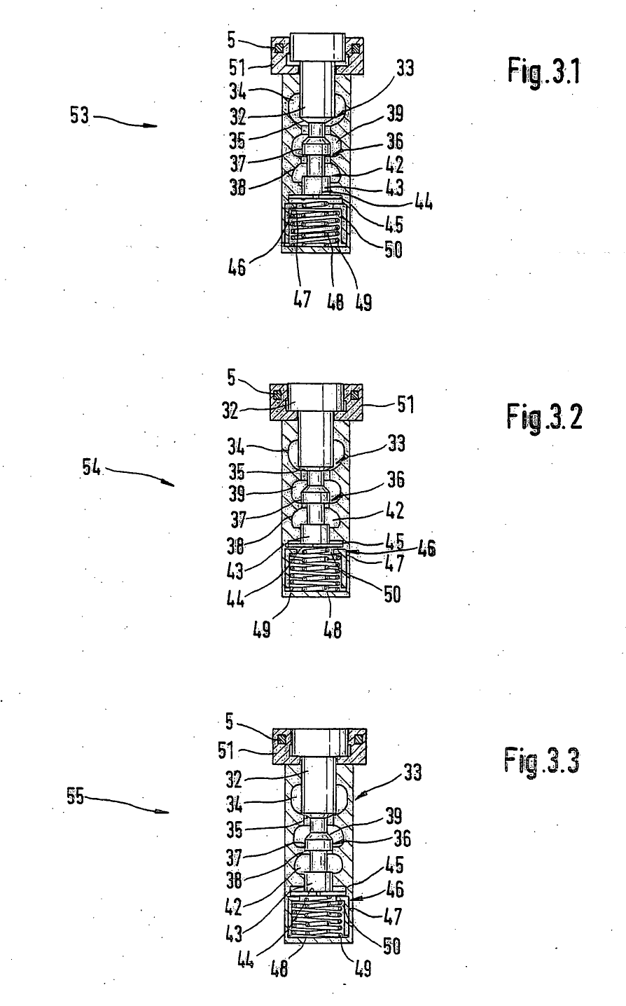

FIG. 3.1 shows the 3/2-way valve according to the invention in a first switched position (valve open).

FIG. 3.1 shows the first switched position 53 of the control valve element 32 of the 3/2-way control valve 31 according to FIG. 2. In this first switched position 53, i.e. when the actuator 3 is without current, the first valve section 33 and the second valve section 36 are placed in their open position by the action of the first spring element 48. In this position, the control valve element 32 is completely open and the fuel is diverted via the first valve section 33 and the second valve section 36. The fuel entering via the first hydraulic chamber 34 from the inlet 41 not shown in FIG. 3.1 travels via the open seat 35 into the second hydraulic chamber 39 and flows via the open control edges 37 of the second valve section 36 and the control edge 38 provided on the housing, into the third hydraulic chamber 42, i.e. into the low-pressure side of the unit injector system. In the depiction shown in FIG. 3.1, the control valve element 32 is brought into the first switched position 53 solely by the prestressing force of the first spring element 48 contained in the cavity 50. The second spring element 49, which acts on the spring-loaded stop 46 inside the cavity 50, is inactive.

FIG. 3.2 shows the 3/3-way valve in a second switched position (first valve section open and second valve section closed).

In the second switched position—labeled with the reference numeral 54—of the control valve element 32 of the 3/3-way control valve 31, the first valve section 33 embodied as a seat valve is still open, while the second valve section 36 embodied as a slide valve is just closing, which is indicated by the contact of the control edge 37 with the control edge 38 provided on the housing. In the second switched position 54, due to the closing of the third hydraulic chamber 42 on the low-pressure side, pressure builds up in the second hydraulic chamber 39, which acts on the control chamber 14 via the control chamber supply line 40 (see depiction according to FIG. 2). The pressure building up in the control chamber 14 in the second switched position 54 prevents the injection valve element 18 from opening, i.e. from unblocking the injection openings 24 at the combustion chamber end of the injection valve 25.

In the second switched position 54 of the control valve element 32 of the 3/2-way control valve, the part of the actuator 3 embodied as a solenoid plunger 5, 51 is supplied with a low current and the position of the control valve element 32 is defined by the spring-loaded stop 46 contained in the cavity 40 underneath the control valve element 32. The position of the spring-loaded stop 46 in turn depends on the dimensioning of the second spring element 49 contained in the cavity 50 and acting on the stop edge 47. In this second switched position 54, the placement of the spring-loaded stop 46, i.e. its position inside the injector housing 2, causes a desired initial injection pressure to build up.

FIG. 3.3 shows the 3/3-way valve in a third switched position, with the first and second valve sections closed.

The third switched position—labeled with the reference numeral 55—of the control valve element 32 of the 3/3-way control valve 31 is reached when, starting from the second switched position 54 of the control valve element 32 shown in FIG. 3.2, more power is supplied to the actuator 3 or the magnetic coil 5 of the plunger mechanism 5, 51 in the head region of the control valve element 32. The supply of more power to the plunger mechanism 5, 51 also moves the first valve section 33 of the control valve element 32 into its closed position, i.e. the pressure increase from the first hydraulic chamber 34 into the control chamber 14 via the control chamber supply line 40 is terminated. When more power is supplied to the plunger mechanism 5, 51 in the head region of the control valve element 32 in order to reach a third switched position 55, when the seat surface 35 of the first valve section 33 is reached, the second valve section 36 configured as a slide valve moves in the direction of a greater overlap of the control edges 37 and 38. In the third switched position 55 according to the depiction in FIG. 3.3 of the control valve element 32, the buildup of pressure is interrupted in the control chamber 14 that acts at least indirectly on the injection valve element 18; in the third switched position 55, the pressure chamber 14 is pressure-relieved via the relief line 52 (see the depiction according to FIG. 2) into the cavity 50 and the third hydraulic chamber 42, i.e. into the low-pressure side of the unit injector system.

The end of an injection phase, whether it be a preinjection, a main injection, or a secondary injection, is achieved by virtue of the fact that the control valve element 32 of the 3/2-way control valve 31 assumes its second switched position 54 again and a pressure increase inside the control chamber 14 occurs via the control chamber supply line 40 as a result of the buildup of pressure in the second hydraulic chamber 39. When there is a pressure increase inside the control chamber 4, 14, the injection valve element 18 returns to its closed position. This then produces the first switched position 53 shown in FIG. 3.1, which results in a pressure-relief of the high-pressure system since both of valve sections 33 and 36 of the control valve element 32 assume their open positions. Multiple triggerings of the actuator 3 can be executed to produce preinjection and secondary injection phases.

In addition to being used in unit pump systems (UPS), the design proposed according to the invention can also be used in unit injector systems (UIS). In these injection systems, not shown here, in lieu of a line connection —as in unit injector systems (UIS)—only a short connecting bore is provided between the high-pressure pump and the injection valve. Thanks to the fact that its control valve element 32 has two valve sections 33, 36 connected in sequence, the design proposed according to the invention can also be used with no trouble in a unit injector system (UIS).

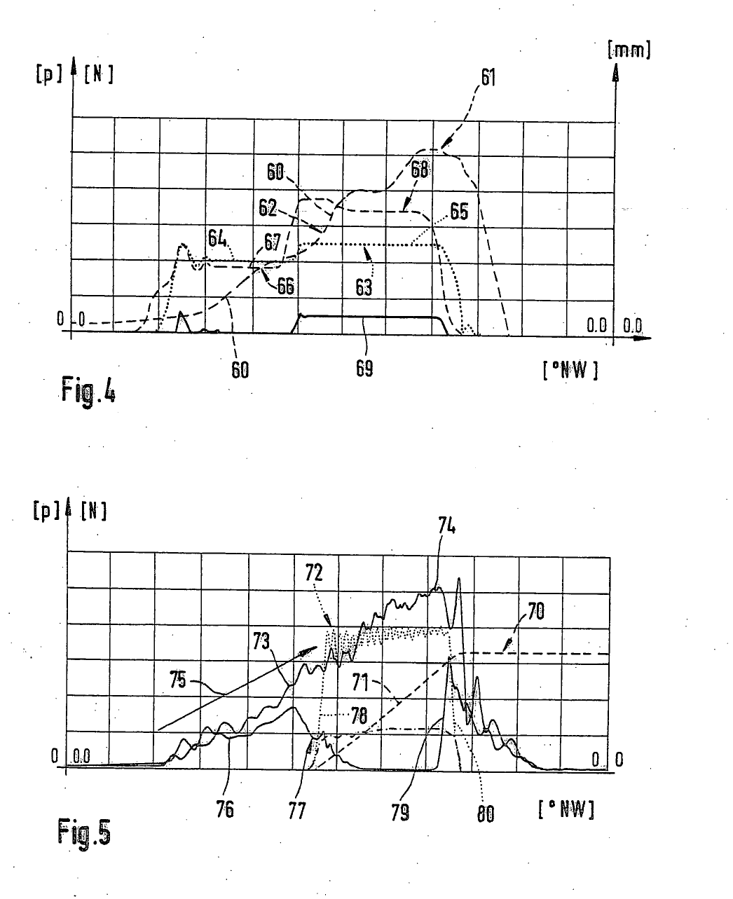

FIG. 4 shows the curves of the pump pressure, solenoid valve force, solenoid valve stroke, and stroke path of the stop 46, plotted as a function of the camshaft angle.

In the depiction according to FIG. 4, the pump pressure curve is identified with the reference numeral 60. The pump pressure reaches its maximum 61 toward the end of the injection. The pump pressure curve 60 is characterized by a pressure increase flank 62 that extends in an essentially linear fashion. The reference numeral 63 identifies the dotted line representing the stroke curve of the control valve element 32, which, depending on the magnetic force, assumes either a first stroke level 64—for example for the pressure increase—or at a higher magnetic valve force, assumes a second stroke level 65. The solenoid valve force 66 that corresponds to the first stroke level 64 remains at a first level 67 (for example 50 newtons) for the duration of the pressure increase without injection. With a greater supply of current to the actuator 3 embodied as a solenoid valve, a second magnetic force level 68 is generated, which corresponds to a second stroke level 65 of the control valve element 32. The reference numeral 69 indicates the path of the mobile stop 46, whose collar 47 is acted on by the second spring element 49.

The depiction according to FIG. 5 shows the curves of the nozzle pressure, nozzle needle stroke, control chamber pressure, and injection rate, plotted as a function of the camshaft angle. The curve of the injected volume 70 is characterized by a linear increase 71 that corresponds to the stroke path 72 of the injection valve element 18. After the injection valve element 18 reaches the closed position and therefore closes the injection openings 24 at the combustion chamber end of the unit injector system, the injected volume transitions into a constant curve represented here by a straight line. As the magnitude of the camshaft angle increases, the pressure 73 on the injection valve element 18 increases steadily, reaching its maximum toward the end of the injection, i.e. shortly before the injection valve element 18 closes against its seat surface in order to close the injection openings 24. The upward-sloping arrow 75 indicates the increase phase of the injection pressure. Parallel to the increase of the injection pressure at the injection valve element 18, as the magnitude of the camshaft angle increases, first the control chamber pressure 76 increases, but this leads to a pressure decrease 77 in the control chamber 14 when it is pressure-relieved due to the opening of the relief line 52, which produces an opening motion 78 of the injection valve element 18. However, when a pressure increase 78 occurs inside the pressure chamber 14 due to the action of the control chamber 14 via the control chamber supply line 40 (see depiction according to FIG. 2), this produces the closing motion of the injection valve element 18 indicated by the reference numeral 80.

### Reference Numeral List

1 injector

2 injector body

3 actuator

4 connections

5 magnetic coil

6 armature device

6.1 armature plate

6.2 armature pin

7 magnetic sleeve

8 retaining nut

9 valve

10 valve element

11 high-pressure inlet

12 annular chamber

13 inlet control

14 control chamber

15 push-rod

16 closing spring

17 thrust-transmitting piece

18 injection valve element

19 disk

20 pin

21 nozzle retaining nut

22 nozzle chamber

23 inlet

24 injection opening

25 injection valve element

30 high-pressure pump inlet

31 3/2-way control valve

32 control valve element

33 first valve section

34 first hydraulic chamber

35 seat surface

36 second valve section

37 control edge

38 housing control edge

39 second hydraulic chamber

40 control chamber supply line

41 first hydraulic chamber inlet

42 third hydraulic chamber (low-pressure side)

43 piston section

44 end surface

45 disk

46 spring-loaded stop

47 collar

48 first spring element

49 second spring element

50 control chamber

51 receiving piece

52 relief line

53 switched position 1

54 switched position 2

55 switched position 3

60 pump pressure curve

61 pump peak pressure

62 pressure increase flank

63 stroke curve of control valve element

64 first stroke level

65 second stroke level

66 magnetic force curve

67 first magnetic force level (50 newtons)

68 second magnetic force level (85 newtons)

69 stroke path stop plate

70 injection rate curve

71 linear increase of injection rate

72 stroke path of injection valve

73 nozzle pressure

74 maximal pressure

75 increase phase

76 curve of control chamber pressure

77 decrease in control chamber pressure

78 opening motion of injection valve element 18

79 pressure increase in control chamber 14

80 closing motion of injection valve element 18

1. A fuel injection apparatus for internal combustion engines, having a fuel pump for each cylinder of the engine, which contains a pump piston that is driven in a stroke motion and delimits a pumping chamber, which is supplied with fuel from a fuel tank, and having a fuel injection valve (25) that has a pressure chamber (22) connected to the fuel pump (13) and an injection valve element (18) that controls at least one injection opening (24) and can be moved in an opening direction counter to a closing force by the pressure prevailing in the pressure chamber (22) in order to unblock the at least one injection opening (24); the injection valve element (18) is also acted on in the closing direction at least indirectly by a pressure prevailing in a control chamber (14), which can be pressure-relieved by means of a control valve (31) that can be actuated by an actuator (3), characterized in that the control valve (31) has a control valve element (32) with a first valve section (33) and a second valve section (36), which are each enclosed by a respective hydraulic chamber (34, 39), of which the first hydraulic chamber (34) communicates with the high-pressure inlet (30) and the second hydraulic chamber (39) can be used to exert pressure on the control chamber (14).

2. The fuel injection apparatus according to claim 1, characterized in that the first valve section (33) and the second valve section (36) are connected in sequence in the opening direction of the injection valve element (18).

3. The fuel injection apparatus according to claim 1, characterized in that the control valve element (32) has a piston section (43), whose end surface (44) oriented away from the actuator (3) is acted on by spring elements (48, 49).

4. The fuel injection apparatus according to claim 3, characterized in that the spring elements (48, 49) are connected in parallel.

5. The fuel injection apparatus according to claim 3, characterized in that the first spring element (48) acts on the piston section (43) of the control valve element (32) and the second spring element (49) is encompassed by a stop (46) that can move inside a cavity (50).

6. The fuel injection apparatus according to claim 1, characterized in that the control valve element (32) has a solenoid plunger mechanism (5, 51) that cooperates with the actuator (3).

7. The fuel injection apparatus according to claim 1, characterized in that the control valve element (32) is provided with a flat armature plate (6.1) that cooperates with a magnetic coil (5) of the actuator (3).

8. The fuel injection apparatus according to claim 1, characterized in that the actuator (3) is embodied as a piezoelectric actuator.

9. The fuel injection apparatus according to claim 1, characterized in that the first valve section (33) is embodied as a seat valve whose first hydraulic chamber (34) can be used to exert pressure on a second hydraulic chamber (39) of the control valve element (32).

10. The fuel injection apparatus according to claim 1, characterized in that the second valve section (36) is embodied as a slide valve whose second hydraulic chamber (39) can be used to exert pressure on the control chamber (14) or can be used to divert fuel into a third hydraulic chamber (42) on the low-pressure side.

11. The fuel injection apparatus according to claim 1, characterized in that in a first switched position (53) of the control valve element (32), the first valve section (33) and the second valve section (36) assume their open positions and the injection valve element (18) is disposed in its open position.

12. The fuel injection apparatus according to claim 1, characterized in that in a second switched position (54) of the control valve element (32), the first valve section (33) assumes its open position, the second valve section (36) assumes its closed position, and a pressure increase occurs in the control chamber (14).

13. The fuel injection apparatus according to claim 1, characterized in that in a third switched position (55) of the control valve element (32), the first valve section (33) assumes its closed position, the second valve section (36) assumes its closed position, and the control chamber (14) can be pressure-relieved via a relief line (52).
